(19) United States
(12) Patent Application Publication
(10) Pub. No.: US 2006/0290308 A1
(43) Pub. Date: Dec. 28, 2006

(54) Switch Assembly for Driving Load and Load Driving Apparatus Including the Same

(76) Inventors: Cheol-Sub Lee, Kyungsangbuk-Do (KR); Seok-ll Kim, Seoul (KR); Seung-In Paek, Seoul (KR)

Correspondence Address: BARLEY SNYDER, LLC, 1000 WESTLAKES DRIVE, SUITE 275, BERWYN, PA, 19312, US

(21) Appl. No.: 11/423,309

(22) Filed: Jun. 9, 2006

(30) Foreign Application Priority Data
Jun. 10, 2005 (KR) 10-2005-049997

(51) Int. Cl. H02P 3/00

(52) U.S. Cl. 318/466

(57) ABSTRACT

A switch assembly for driving a load, such as a vehicle seat, for a load driving apparatus comprises a pair of relay elements connected between an electric power supply end and a load driving motor that drives the load in a forward or reverse direction. The relay elements connect both ends of the load driving motor to any one of the electric power supply end and a grounding end. At least one switch for driving the load is connected to a side of each of the relay elements so as to electrically conduct the respective relay element, and a pair of connection terminals connects a side of each of the relay elements to an outer controller.

### FIELD OF THE INVENTION

The invention relates to a load driving apparatus and, more particularly, to a switch assembly for driving a load, such as a vehicle seat, and a load driving apparatus including the same.

### BACKGROUND OF THE INVENTION

In general, a vehicle seat is designed to be capable of controlling a position of the seat to conform to a body size of a driver or a passenger. For example, vehicles of low level specification are designed to be capable of slidingly moving the seat in a forward or reverse direction or controlling an angle of a backrest of the seat by operating a mechanical lever switch. A driving apparatus for a seat of such low level specification, however, requires inconvenient manual operation. A driving apparatus for a seat of high level specification has therefore been developed.

The seat driving apparatus of the high level specification comprises a motor, a plurality of relays, and electric switches. The seat is slidingly moved and an angle of the backrest is controlled automatically by the operation of the electric switches. The seat driving apparatus of the high level specification therefore has the advantage that an operator can control the seat simply and conveniently by the simple operation of the electric switches.

A seat driving apparatus of an even higher level specification has also been developed. This seat driving apparatus incorporates a memory finction into the seat driving apparatus of the high level specification called an Integrated Memory System (IMS). The IMS comprises an operation switch, an IMS module including a memory and relays, and motors. The IMS “memorizes” the driver's seat position, the tilt of the seat in a forward and backward direction, the angle of the backrest of the seat, etc., so that it is possible to automatically adjust the position of the seat, if required, to the “memorized” positions. This is very advantageous when several different drivers use the same vehicle.

Because a buyer decides which type of seat driving apparatus is to be incorporated into a vehicle, the maker of the vehicle must assemble parts conforming to the various specification options of the buyer after supplying parts for manufacturing the seat driving apparatus to the manufacturing line of the vehicles. There is therefore an increased amount of vehicle assembly procedures. A similar problem also occurs in power steering devices, where the position of the power steering is controlled automatically by a motor.

### BRIEF SUMMARY OF THE INVENTION

It is therefore an object of the present invention to provide a switch assembly for driving a load, such as a vehicle seat, and load driving apparatus including the same, which is designed to be capable of realizing the load driving apparatus of specifications different from each other in a module. Another object of the present invention is to provide a switch assembly for driving a load, such as a vehicle seat, and load driving apparatus including the same, which is designed to be capable of reducing the vehicle assembly procedure with the module applicable to the load driving apparatus of plural specifications. It is further an object of the invention to provide a reduced size load driving apparatus provided with an IMS module.

This and other objects are achieved by a switch assembly for driving a load, such as a vehicle seat, comprising a pair of relay elements connected between and an electric power supply end and a load driving motor that drives the load in a forward or reverse direction. The relay elements connect both ends of the load driving motor to any one of the electric power supply end and a grounding end. At least one switch for driving the load is connected to a side of each of the relay elements so as to electrically conduct the respective relay element, and a pair of connection terminals connects a side of each of the relay elements to an outer controller.

This and other objects are further achieved by a load driving apparatus comprising a switch assembly for driving a load and load driving controller. The switch assembly for driving the load includes a pair of relay elements connected between an electric power supply end and a load driving motor that drives the load in a forward or reverse direction. The relay elements connect both ends of the load driving motor to any one of the electric power supply end and a grounding end. At least one switch for driving the load is connected to a side of each of the relay elements so as to electrically conduct the respective relay element. The load driving controller is connected to a side of each of the relay elements and electrically conducts the relay element so that the load can be moved to a position previously registered at an inner memory address.

### BRIEF DESCRIPTION OF THE DRAWINGS

FIG. 1 is a schematic diagram of a seat driving apparatus including a switch assembly for driving a seat;

FIG. 2 is a schematic circuit diagram of a first embodiment of the seat driving apparatus shown in FIG. 1;

FIG. 3 is a schematic circuit diagram of a first embodiment of the seat driving apparatus shown in FIG. 1;

FIG. 4 is a schematic circuit diagram of a second embodiment of the seat driving apparatus shown in FIG. 1;

FIG. 5 is a schematic circuit diagram of a third embodiment of the seat driving apparatus shown in FIG. 1; and

FIG. 6 is a schematic circuit diagram of a fourth embodiment of the seat driving apparatus shown in FIG. 1.

### DETAILED DESCRIPTION OF THE INVENTION

One embodiment of the invention will now be described in greater detail with reference to the attached drawings. The invention will be described in relation to a seat driving apparatus including a switch assembly 100 for driving a seat, the seat driving apparatus being commonly known as a load driving apparatus and the switch assembly 100 for driving the seat being commonly known as a switch assembly for driving a load.

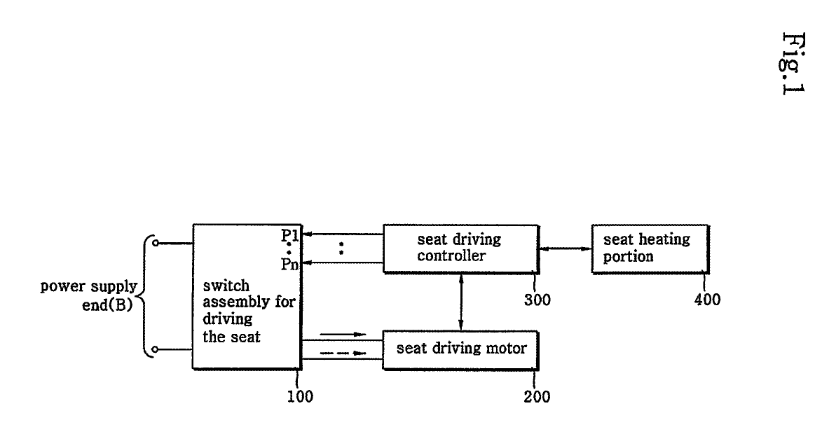

For a seat driving apparatus of a high level specification, the switch assembly 100 for driving the seat is connected between a power supply end B and a seat driving motor 200 (load driving motor), as shown in FIG. 1. For a seat driving apparatus of a higher level specification, the switch assembly 100 for driving the seat is connected between the power supply end B and the seat driving motor 200 and a seat driving controller 300, as additionally shown in FIG. 1. The seat driving controller 300 may also be connected to a seat heating portion 400.

The switch assembly 100 for driving the seat is constructed so that the seat is driven in a forward or reverse direction by connecting both ends of the seat driving motor 200 to any one of a power supply end and a grounding end according to either the operation of a user or the operation of the seat driving controller 300. Although the seat driving motor 200, which is driven rotationally in a forward or reverse direction by being supplied of driving power through the switch assembly 100 realized into one motor according to the usage for driving the seat, the seat driving apparatus may additionally comprise additional motors to drive a slide for the seat, to drive a recliner for the seat, to drive a front tilt and a rear tilt for the seat, etc.

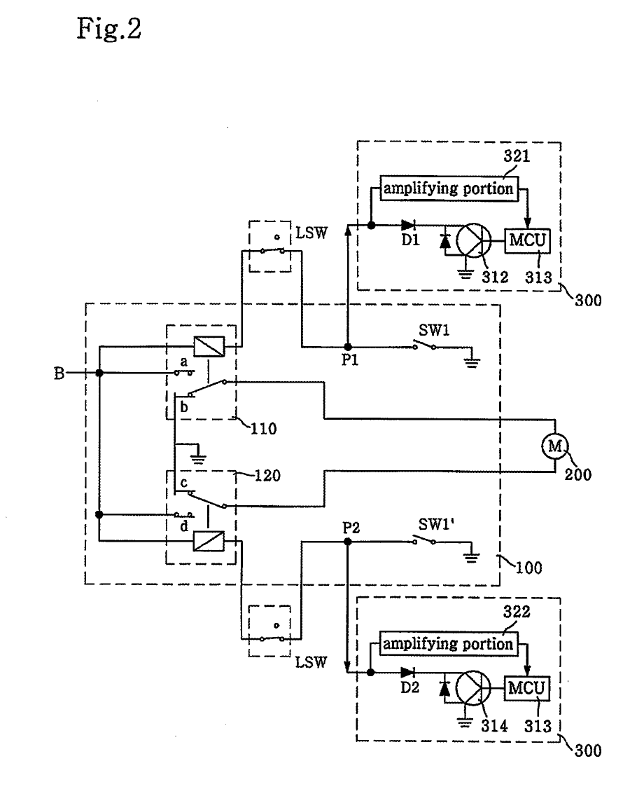

FIG. 2 is a schematic circuit diagram of a first embodiment of the seat driving apparatus shown in FIG. 1. In this embodiment, the switch assembly 100 for driving the seat comprises at least one pair of relay elements 110, 120 and at least one switch SW1, SW1′ for driving the seat. The relay elements 110, 120 are connected between the seat driving motor 200 in the forward or reverse direction and the power supply end B for connecting both ends of the seat driving motor 200 to any one of the power supply end B and the grounding end. The switch SW1, SW1′ is connected to any one side of the relay elements 110, 120 for electrically conducting the relay elements 110, 120. In this regard, each side of the switch SW1, SW1′ is grounded, and the other side thereof is connected to a common contact of the relay elements 110, 120 and connecting terminals P1, P2, which are connected to the seat driving controller 300. In addition, a pair of limit switches LSW can be provided between the relay elements 110, 120 and the switches SW1, SW1′ for restricting the movement of the respective seat.

The seat driving controller 300 comprises an MCU 313, transistor elements 312, 314, voltage dropping elements D1, D2, and amplifying portions 321, 322 for amplifying a voltage level. The seat driving controller 300 outputs a control signal for moving the seat to a position registered previously at a memory address inside the MCU 313. In this regard, the driving power is applied to the motor 200 after the electrical conduction of a relay element in the switch assembly 100 for driving the seat based on a logic level of the control signal. Because the procedure of registering the information about the position of the seat for every driver at the memory address in the MCU 313 is well known in the field of IMSs, further description thereof will be omitted.

The seat driving controller 300 can output a control signal to the seat heating portion 400, a control signal for controlling an angle of a rear view mirror, a control signal for controlling an angle of a side mirror, and a control signal for controlling an electronic folding mirror with the corresponding modules.

The above description is made in relation to the circuit constitution corresponding to the seat driving motor 200. Accordingly, the assembly circuit of the above constitution can be provided to conform to the seat slide, the recliner, and the tilt. Further, according to the circumstances, respective assembly circuit for driving the seat slide, the recliner, and the tilt can be integrated into a module. Also, while the switch SW1, SW1′ for driving the seat can be realized in different switches in physical, it can be realized into a switch having two contacts.

With regard to the seat driving apparatus shown in FIG. 1, in the case of the seat driving apparatus of the high level specification, the driver can move the seat in the forward or reverse direction by operating the switches SW1, SW1′. In other words, when the driver turns on the switch SW1 for driving the seat, the relay element 110 is electrically conducted to thereby move the relay contact from b to a to thereby drive the motor 200 in the forward direction. When the switch SW1′ for driving the seat is turned on, the relay element 120 is electrically conducted to move the relay contact from c to d to thereby drive the motor 200 in the reverse direction. Accordingly, the seat can be moved slidingly in the forward or reverse direction according to the driver's operation of the switches SW1, SW1′.

In the case of the seat driving apparatus of the higher level specification, the driver can move the seat in the forward or reverse direction in a manner identical with that described above with regard to the case of the seat driving apparatus of the high level specification. In case of the seat driving apparatus of the higher level specification, however, the seat will move automatically to the “memorized” position designated by the driver. In other words, when the MCU 313 in the seat driving controller 300 is inputted of the command designating the address of the driver, a control signal is outputted to the transistor 312 in the seat controller 300 to move the seat to the position registered previously at the corresponding memory address. For example, when the MCU 313 applies a control signal of “low” level to the base end of the transistor 312, the relay element 110 is electrically conducted to move the relay contact from b to a thereby driving the motor 200 in the forward direction to slidingly move the seat in the forward direction. In this case, the MCU 313 will output the “low” level control signal continuously till the seat is moved to the designated position. The method of moving the seat to the designated position is well known in the art. In this regard, the present position of the seat can be easily detected, if a magnet and a hole sensor (can be substituted by a potential meter or a lead sensor) rotating together with a rotation body of the seat driving motor 200.

During the output of the control signal of the “low” level from the MCU 313, it is possible for the MCU 313 to be applied of the switch operation signal level-amplified to “high” level from the amplifying portion 321 through another input port. That is, what is further to be considered in the seat driving apparatus of the higher level specification is a manual operation command, which can be produced in the course of the movement of the seat to the position registered previously. In this regard, the MCU 313 in the seat driving controller 300 can control the seat driving motor 200 by giving a priority to the manual operation command. For example, when the switches SW1, SW1′ were turned on by the driver during the application of the control signal of the “low” level to the base end of the transistor 312 or the base end of the transistor 314, the MCU 313 receives the switch operation signal of the “low” level as an interrupt signal through the amplifying portion 321 to thereby invert the level of the control signal outputted from the “low” level to “high” level. In this case, the motor 200 is driven by the power supply based on the operation of the switches SW1, SW1′ for driving the seat as was in the manual mode.

As described above, the seat driving apparatus can be programmed that, when the manual operation command is received during the driving of the seat in the automatic mode, the corresponding seat driving motor 200 is driven based on the manual operation command, and then remaining portions, which were not controlled manually, such as the slide, or the front tilt, and the like can be controlled automatically by using the information of the positions registered previously.

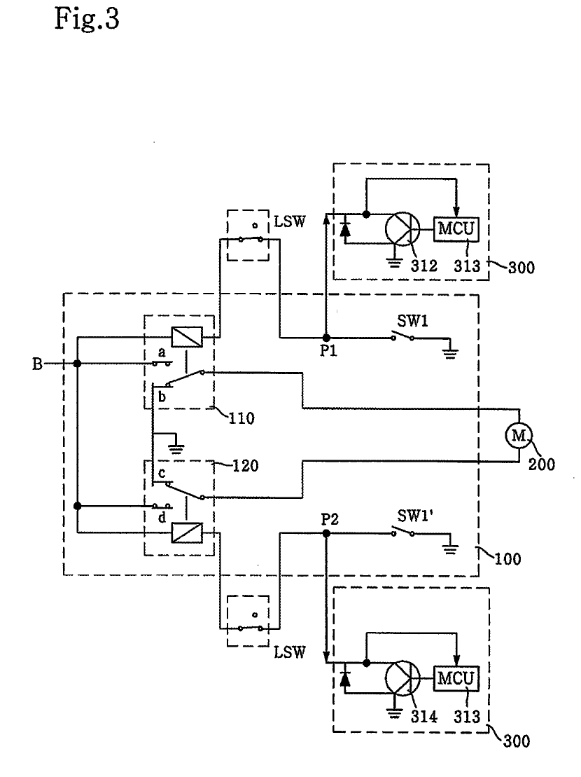

As shown in FIG. 3, the seat driving controller 300 for realizing the seat driving apparatus of the higher level specification can be realized by comprising the MCU 313 and a transistor. The MCU 313 of the seat driving controller 300 receives the switch operation signal of the “low” level as the interrupt signal to thereby invert the level of the control signal outputted to the “high” level signal, when the switch for driving the seat recliner is turned on by the driver during the application of the control signal of the “low” level into the base end of the transistor for moving the seat slidingly. Accordingly, the motor for driving the seat recliner is driven by the supply of the power based on the operation of the switch for driving the seat as was in the manual mode.

The switch assembly 100 for driving the seat therefore can be used for any seat driving apparatus irrespective of the specification, because the seat is designed to move slidingly in the forward or reverse direction by the operation of the switches SW1, SW1′ and because it is also designed to move in the forward or reverse direction by the application of the signal for driving the relay from the seat driving controller 300 through the connection terminals P1, P2.

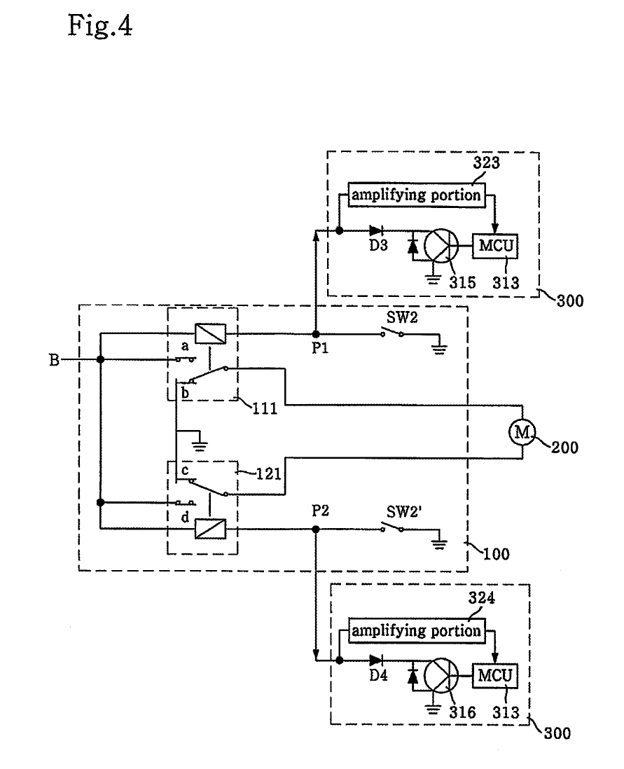

FIG. 4 is a schematic circuit diagram of a second embodiment of the seat driving apparatus shown in FIG. 1. In this embodiment, the seat driving motor 200 has a built-in self protection circuit, and the limit switches LSW have been removed from the switch assembly 100 for driving the seat. Because the operation of the switch assembly 100 for driving the seat of FIG. 4 is substantially identical to the operation of the switch assembly 100 for driving the seat of FIG. 2, further description thereof will be omitted.

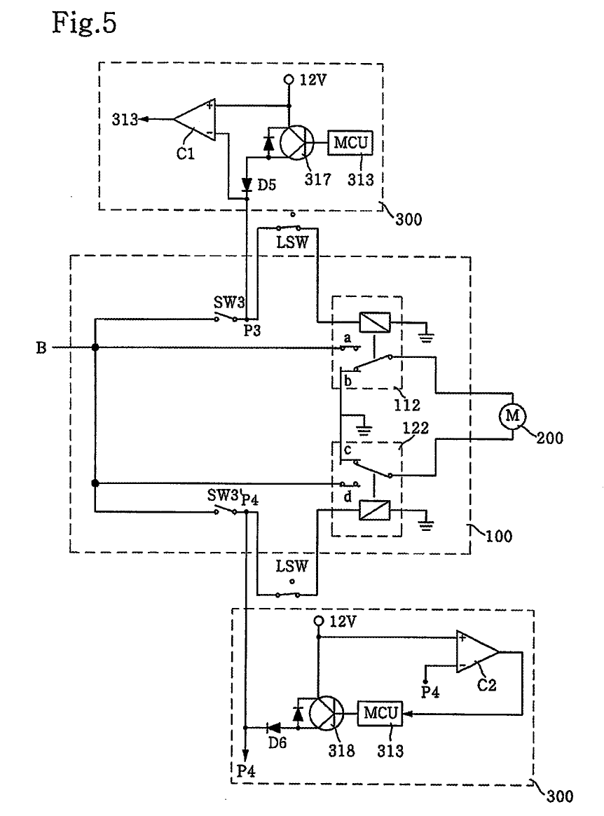

FIG. 5 is a schematic circuit diagram of a third embodiment of the seat driving apparatus shown in FIG. 1. In this embodiment, a pair of relay elements 112, 122 are connected between the seat driving motor 200 in the forward or reverse direction and the power supply end B, for connecting both ends of the motor 200 to any one of the power supply end B and the grounding end. At least one switch SW3, SW3′ for driving the seat is connected to any one side of the pair of relay elements 112, 122 for electrically conducting any one of the relay elements 112, 122. A pair of connection terminals P3, P4 connects one side of the pair of relay elements 112, 122 to a seat driving controller 300. One of the sides of the switch SW3, SW3′ is connected to the power supply end B, and the other side thereof is connected to a common contact of the relay elements. The connection terminals P3, P4 and a pair of limit switches LSW are connected between the respective one side of the pair of the relay elements 112, 122 and the switches SW3, SW3′ for restricting the movement of the seat.

In the case of the seat driving apparatus of the high level specification, if the driver turns on the switch SW3 for driving the seat, the relay element 112 is electrically conducted to move the relay contact from b to a to thereby drive the motor 200 in the forward direction. If the switch SW3′ for driving the seat is turned on, the relay element 122 is electrically conducted to move the relay contact from c to d to thereby drive the motor 200 in the reverse direction. Accordingly, the seat moves slidingly in the forward or reverse direction based on the driver's operation of the switches SW3, SW3′.

In the case of the seat driving apparatus of the higher level specification, the driver can move the seat in the forward or reverse direction in a manner identical with that described above with regard to the case of the seat driving apparatus of the high level specification. in case of the seat driving apparatus of the higher level specification, however, when the address designation command is inputted by the driver, the MCU 313 outputs the control signal to a transistor 317 in the seat controller 300 for moving the seat to a position registered previously in the corresponding memory address. For example, when the MCU 313 applies the control signal of the “low” level to the base end of the transistor 317, the relay element 112 is electrically conducted to move the relay contact from b to a thereby driving the motor in the forward direction to move the seat slidingly in the forward direction.

When the switch SW3′ for driving the seat is turned on by the driver during the application of the control signal of the “low” level to the base end of the transistor 317, the MCU 313 detects the rotation state (for instance, the change of the rotation speed) of the motor 200 by means of a hole sensor to thereby make it possible to determine whether the manual operation command is inputted by the driver or not. According to the result of the determination, the control signal of the “low” level can be inverted to the control signal of the “high” level such that the motor 200 connected only to the switch for driving the seat can be driven in the manual mode. Depending on the circumstances, it is possible to determine whether the manual operation command is inputted by the driver by monitoring the results obtained through the comparison of the voltage differential between the power supply applied by the MCU 313 to the transistor 317 via comparators C1, C2 and one side P3 of the switches SW3, SW3′.

The switch assembly 100 for driving the seat therefore can be advantageously programmed so that when the manual operation command is received during the driving of the seat in the automatic mode, the corresponding motor 200 is driven based on the manual operation command, and then remaining portions, which were not controlled manually, such as the slide, the front tilt, etc. can be controlled automatically by using the information of the positions previously registered.

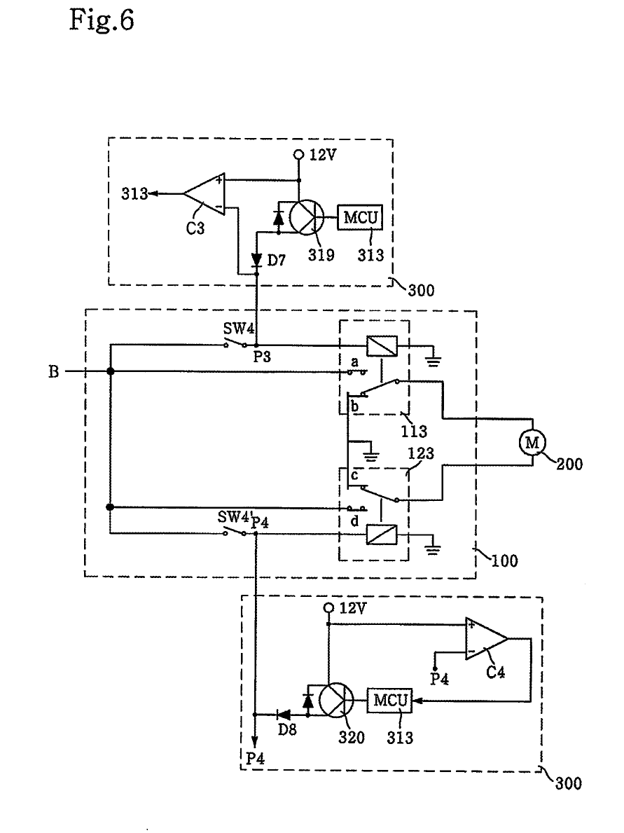

FIG. 6 is a schematic circuit diagram of a fourth embodiment of the seat driving apparatus shown in FIG. 1. In this embodiment, the limit switches LSW have been removed from the switch assembly 100 for driving the seat shown in FIG. 5, and the motor 200 has a built-in self protection circuit. The seat is also designed to move slidingly in the forward or reverse direction by the operation of a switch SW4, SW4′. The seat moves in the forward or reverse direction by the application of the signal for driving the relay from the seat driving controller 300 via the connection terminals P3, P4, so that the switch assembly 100 for driving the seat can be used irrespective of the specifications. Because the operation of the switch assembly 100 for driving the seat of FIG. 6 is substantially identical to the operation of the switch assembly 100 for driving the seat of FIG. 5, further description thereof will be omitted.

As described above, the switch assembly 100 for driving the seat (or the power steering) according to the invention is designed so that the seat is moved slidingly in the forward or reverse direction by the operation of the switch SW1, SW1′, SW2, SW2′, SW3, SW3′, SW4, SW4′, or the seat is moved in the forward or reverse direction by the operation of the seat driving controller 300. Accordingly, the invention is advantageous in reducing the assembly procedure of the vehicle because it is possible to realize the load driving apparatuses of different specifications from one module. Also, it is possible to minimize the labor cost and physical cost required for the management of plural modules. Further, it is advantageous that it is possible to make the size of the IMS smaller because the present invention provides the load driving controller removed of the relay from the general IMS module.

The foregoing illustrates some of the possibilities for practicing the invention. Many other embodiments are possible within the scope and spirit of the invention. For example, although it is not described in the above embodiments, it is possible to integrate the switch assembly 100 for driving the seat and the seat driving apparatus in a module depending on the circumstances. It is, therefore, intended that the foregoing description be regarded as illustrative rather than limiting, and that the scope of the invention is given by the appended claims together with their full range of equivalents.

What is claimed is:

1. A switch assembly for driving a load, comprising:
a pair of relay elements connected between an electric power supply end and a load driving motor that drives the load in a forward or reverse direction, the relay elements connecting both ends of the load driving motor to any one of the electric power supply end and a grounding end;
at least one switch for driving the load connected to a side of each of the relay elements so as to electrically conduct the respective relay element; and
a pair of connection terminals connecting a side of each of the relay elements to an outer controller.

2. The switch assembly for driving the load according to claim 1, further comprising a limit switch connected between the relay element and the switch for restricting the movement of the load.

3. The switch assembly for driving the load according to claim 1, wherein one side of the switch is grounded and another side of the switch is connected to a common contact of the connection terminal and the relay element.

4. The switch assembly for driving the load according to claim 1, wherein one side of the switch is connected to the electric power supply end and another side of the switch is connected to a common contact of the connection terminal and the relay element.

5. The switch assembly for driving the load according any one of claims 1, wherein the load is a vehicle seat.

6. The switch assembly for driving the load according any one of claims 1, wherein a plurality of the switch assemblies is assembled into a single module.

7. A load driving apparatus, comprising:
a switch assembly for driving a load, the switch assembly includes a pair of relay elements connected between an electric power supply end and a load driving motor that drives the load in a forward or reverse direction, the relay elements connecting both ends of the load driving motor to any one of the electric power supply end and a grounding end, and at least one switch for driving the load connected to a side of each of the relay elements so as to electrically conduct the respective relay element; and
a load driving controller connected to a side of each of the relay elements, the load driving controller electrically conducts the relay element so that the load can be moved to a position previously registered at an inner memory address.

8. The load driving apparatus according to claim 7, further comprising a limit switch connected between the relay element and the switch for restricting the movement of the load.

9. The load driving apparatus according to claim 7, wherein the switch assembly for driving the load and the load driving controller are integrated into a module.

10. The load driving apparatus according to claim 7, wherein one side of the switch is grounded and another side of the switch is connected to a common contact of the relay element and the load driving controller.

11. The load driving apparatus according to claim 10, wherein the load driving controller includes a voltage dropping element connected to each of the common contacts.

12. The load driving apparatus according to claim 11, wherein the load driving controller includes amplifying portions connected in parallel with each of the voltage dropping elements.

13. The load driving apparatus according to claim 12, wherein the load driving controller includes a main control unit for outputting a control signal for electrically conducting the relay element so that the load is moved to the position previously registered at the inner memory address and for inverting an output of the control signal when the level of any one switch operation signal inputted from the amplifying portions is changed.

14. The load driving apparatus according to claim 13, wherein the load driving controller includes transistors for grounding one side of the voltage dropping element based on a logic level of the control signal outputted from the main control unit.

15. The load driving apparatus according to claim 16, wherein the load driving controller inverts the output of the control signal when the switch is operated during the output of the control signal for electrically conducting the relay element.

16. The load driving apparatus according to claim 7, wherein one side of the switch is connected to the electric power supply end and another side of the switch is connected to a common contact of the relay element and the load driving controller.

17. The load driving apparatus according to claim 7, wherein the load is a vehicle seat.
